(19) United States
(12) Patent Application Publication
(10) Pub. No.: US 2014/0081714 A1
(43) Pub. Date: Mar. 20, 2014

(54) SYSTEMS AND METHODS OF REWARDING USERS IN AN ON-DEMAND SYSTEM

(71) Applicant: salesforce.com, inc., San Francisco, CA (US)

(72) Inventors: Daniel Debow, San Francisco, CA (US); David Stein, San Francisco, CA (US); Jager McConnell, San Francisco, CA (US); Ciara Peter, San Francisco, CA (US); Maksim Ovsyannikov, San Francisco, CA (US); Woodson Martin, Atherton, CA (US); Kyle Lui, San Francisco, CA (US); Omar Guerrero Tapia, San Francisco, CA (US); Pasha Kazatsker, San Francisco, CA (US); Tao Sean Chen, Emeryville, CA (US); Kallin Nagelberg, San Francisco, CA (US); Ashwin Kashyap, San Jose, CA (US); Ryan Dewsbury, San Francisco, CA (US); Iurie Cangea, San Francisco, CA (US); Austin Tam, San Francisco, CA (US); Alfred Yang, San Francisco, CA (US); James Tam, San Francisco, CA (US)

(73) Assignee: salesforce.com, inc., San Francisco, CA (US)

(21) Appl. No.: 14/032,129

(22) Filed: Sep. 19, 2013

Related U.S. Application Data
(60) Provisional application No. 61/703,164, filed on Sep. 19, 2012.
(60) Provisional application No. 61/847,412, filed on Jul. 17, 2013.
(60) Provisional application No. 61/860,673, filed on Jul. 31, 2013.

(51) Int. Cl. G06Q 10/06

(52) U.S. Cl. CPC G06Q 10/06398
USPC 705/7.42

(57) ABSTRACT

The technology disclosed relates to tracking performance and initiatives of employees and providing real-time recognition for their successes and contributions through customizable recognition awards. In particular, it relates to automatically awarding recognition awards to an employee by evaluating the employee's current performance against progress features and exception features. The progress features indicate a progression of an individual across a work cycle and exception features indicate high performance of the individual during the work cycle. Thus the recognition awards are automatically awarded when the current performance of the employee evidences accomplishment of milestones or high performance.

### RELATED APPLICATION

This application claims the benefit of three US provisional Patent Applications, including: No. 61/703,164, entitled, “Systems and Methods for Interacting with Employees,” filed 19 Sep. 2012 (Attorney Docket No. SALE 1038-1/1039PROV); No. 61/847,412, entitled, “Systems and Methods for Auto-Thanking in a Social Environment,” filed 17 Jul. 2013 (Attorney Docket No. SALE 1038-3/1211PROV); and No. 61/860,673, entitled, “Systems and Methods for Auto-Badging in an On-Demand System,” filed 31 Jul. 2013 (Attorney Docket No. SALE 1038-2/1210PROV). The provisional applications are hereby incorporated by reference for all purposes.

This application is related to US Patent Application entitled “Systems and Methods of Coaching Users in an On-Demand System,” filed contemporaneously (Attorney Docket No. SALE 1059-2/1169US). The related application is incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Social media platforms have transformed the way users connect and share information. Yet the systems most organizations use to manage work are designed for the hierarchical, siloed, slow-moving workplace. Such systems automate needless bureaucracy and painful reviews instead of improving productivity and results. And they often feel like work on top of work.

An opportunity arises to automatically reward employees for their successes and contributions by comparing their current performance to work goals and performance of their relevant colleagues. Improved employee experience and engagement, improved sales and revenues, and higher employee satisfaction and retention may result.

### SUMMARY

The technology disclosed relates to tracking performance and initiatives of employees and providing real-time recognition for their successes and contributions through customizable recognition awards. In particular, it relates to automatically awarding recognition awards to an employee by evaluating the employee's current performance against progress features and exception features. The progress features indicate a progression of an individual across a work cycle and exception features indicate high performance of the individual during the work cycle. Thus the recognition awards are automatically awarded when the current performance of the employee evidences accomplishment of milestones or high performance.

Other aspects and advantages of the present technology can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 shows an example recognition environment of rewarding users in an on-demand system.

FIG. 2 illustrates one implementation of historical performance data generated from reports.

FIGS. 3A-3C illustrate one implementation of progress features extracted from historical performance data.

FIG. 4 shows one implementation of exception features extracted from historical performance data.

FIG. 5 illustrates one implementation of automated recognition of users in an on-demand system.

FIGS. 6A and 6B are one implementation of user triggered recognition of users in an on-demand system.

FIG. 7 is one implementation of a recognition schema that can be used for rewarding users in an on-demand system.

FIG. 8 shows a flowchart of one implementation of rewarding users in an on-demand system.

FIG. 9 is a block diagram of an example computer system used for rewarding users in an on-demand system.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

The technology disclosed relates to rewarding users in an on-demand system by using computer-implemented systems. The technology disclosed can be implemented in the context of any computer-implemented system including a database system, a multi-tenant environment, or the like. Moreover, this technology can be implemented using two or more separate and distinct computer-implemented systems that cooperate and communicate with one another. This technology may be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

As used herein, the “identification” of an item of information does not necessarily require the direct specification of that item of information. Information can be “identified” in a field by simply referring to the actual information through one or more layers of indirection, or by identifying one or more items of different information which are together sufficient to determine the actual item of information. In addition, the term “specify” is used herein to mean the same as “identify.”

Examples of systems, apparatus, and methods according to the disclosed implementations are described in a “sales” context. The examples of sales performance metrics are being provided solely to add context and aid in the understanding of the disclosed implementations. In other instances, examples of performance metrics in other industries like energy and utilities, education, agriculture and mining, medical services, etc. may be used. Other applications are possible, such that the following examples should not be taken as definitive or limiting either in scope, context, or setting. It will thus be apparent to one skilled in the art that implementations may be practiced in or outside the “sales” context.

A recent study from Market Tools found that 76 percent of workers are unsatisfied with the amount of recognition they receive at work, while 77 percent said they would work harder if their efforts were better recognized. Praise is a powerful motivator for employees. When that praise is coupled with a prize, employees' performance is driven even further. A survey performed by Globoforce stated that 83 percent employees are further motivated by recognition that includes a reward than recognition with no associated reward. 94 percent of respondents said positive feedback has a greater impact on performance.

With the technology disclosed, organizations can create a culture of meaningful recognition at work. Employees can use the technology disclosed to recognize colleagues with custom recognition awards such as badges, thanks, likes, stars, smileys, thumbs up, bonuses, stickers, ratings, etc. that reflect organization's culture and values, create a positive work environment, motivate high performance, and increase employee morale. In one aspect, the recognition that employees receive becomes part of their social profiles and performance summaries, allowing employees to build their reputation and colleagues to identify experts.

The technology disclosed provides insights into achievements of sales representatives by measuring the performance of sales activities and determining the effectiveness of the sales representatives. In some implementations, managers can view dashboards summarizing sales representatives' goal achievements, pipeline reports, milestone reports that compare sales representatives' current performance to historical performance of the organization and of the relevant colleagues. By constantly measuring sales representatives' current performance against their sale targets and goals and among other sales representatives with similar sale targets and goals, the technology disclosed can identify and reward high performing sales representatives.

The technology disclosed also provides a social performance management platform like Salesforce's Work.com, which helps organizations align, motivate, and drive performance. The technology disclosed can be used to manage in real-time, drive alignment with goals, and reward top performers with recognition awards. In some implementations, the technology disclosed can reward great performance with gift cards directly from within a (CRM) system. Recipients can collect points awarded by managers and colleagues that can later be redeemed from e-commerce platforms external to the CRM system like Amazon and eBay.

In other implementations, the technology disclosed can make the recognition awards more meaningful by customizing the image and the tag, adding skills, and making clear to the recipients what they did to deserve the recognition. In yet other implementations, the recognition awards can be added to performance summaries of the employees to incorporate real examples of how their work positively impacted the organization. In one implementation, recognition awards can be customized to profile the intended recipients as having different skills such as collaboration, communication, evangelism, helpfulness, mentorship, results, teaching, etc. In another implementation, the technology disclosed can identify “top recipients” of the recognition awards.

### Recognition Environment

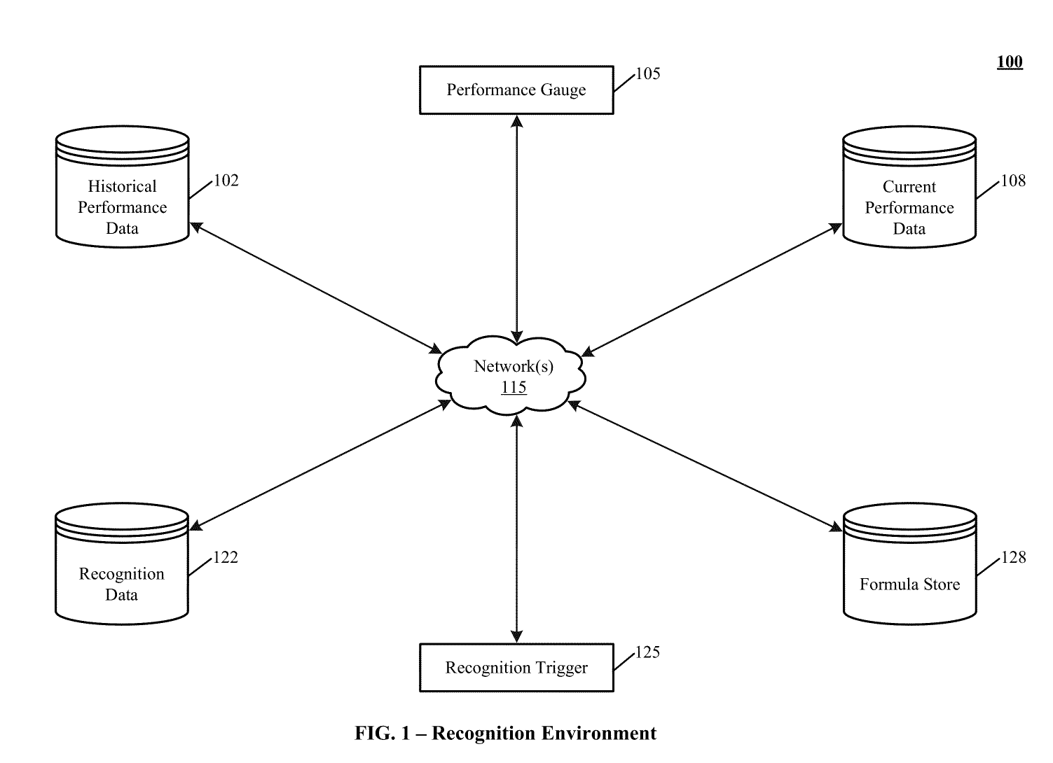

FIG. 1 shows an example recognition environment 100 of rewarding users in an on-demand system. FIG. 1 includes historical performance data 102, current performance data 108, recognition data 122, and formula store 128. FIG. 1 also includes network(s) 115, performance gauge 105, and recognition trigger 125. In other implementations, environment 100 may not have the same elements as those listed above and/or may have other/different elements instead of, or in addition to, those listed above such as an assignment engine, a fund store, or an application running on a computing device. The different elements can be combined into single software modules and multiple software modules can run on the same hardware.

In some implementations, network(s) 115 can be any one or any combination of Local Area Network (LAN), Wide Area Network (WAN), WiFi, telephone network, wireless network, point-to-point network, star network, token ring network, hub network, peer-to-peer connections like Bluetooth, Near Field Communication (NFC), Z-Wave, ZigBee, or other appropriate configuration of data networks, including the Internet.

In some implementations, the engines can be of varying types including workstations, servers, computing clusters, blade servers, server farms, or any other data processing systems or computing devices. The engines can be communicably coupled to the databases via a different network connection. For example, performance gauge 105 can be coupled via the network(s) 115 (e.g., the Internet) and recognition trigger 125 can be coupled via a direct network link or a different network connection.

In some implementations, databases can store information from one or more tenants into tables of a common database image to form a multi-tenant database system (MTS). A database image can include one or more database objects. In other implementations, the databases can be relation database management systems (RDBMSs), object oriented database management systems (OODBMSs), distributed file systems (DFS), no-schema database management systems, or any other data storing systems or computing devices.

In general, a CRM system allows organizations to manage business relationships and the data and information associated with them. It allows organizations to store customer and contact information as reports. A report returns a set of records that meets certain criteria, and displays it in organized rows and columns. Report data can be filtered, grouped, sorted, and displayed graphically as a chart. A report type defines the set of records and fields available to a report based on the relationships between a primary object and its related objects. Reports display only records that meet the criteria defined in the report type. In one implementation, a tabular report can display the row of records in a table like format with grand total. In another implementation, a summary report can group and sort rows of data to display subtotals. For instance, in a recruiting application, a summary report can be used to display open positions classified by department name. In yet another implementation, a matrix report can summarize information in a grid format and group records by columns and rows.

Applied to sales and other CRM activities, summary and matrix reports, dashboards and scorecards (collectively, reports and displays) provide graphical representations of performance. In one implementation, dashboards show data from source reports as visual components, which can be charts, gauges, tables, or metrics. Dashboards can highlight specific data, trends, and deviations from the trends such as a pipeline graph by sales region, opportunities, closed revenue by quarter, order history by account, sales actual vs. quota per sales representative, opportunities per sales representative, closed deals per sales representative, etc.

The technology disclosed builds on these reports and displays by automatically determining performance criteria used by an organization. Performance criteria automatically extracted can be analyzed and auto-badging and auto-thanking criteria established. Filtering, sorting and subtotaling structures of reports and displays are particularly useful in automatically determining performance criteria. Filtering structures show a viewer a subset of organization data of personal interest. For instance, a manager filters data to focus on his work group. Filtering structures can be extracted from query criteria selectors, SQL queries, scripts, API calls and equivalent filtering structures used to select data included in reports and displays. Sorting and subtotaling structures organize and summarize data into strata. For instance, a sales report is sorted by territory and sales representative within the territory and subtotaled by territory. This sorting and subtotaling structure reveals that sales representatives and territories are evaluated for performance. The sales representatives and territories are compared to each other. Sorting criteria can be extracted from sort criteria selectors, SQL queries, scripts, API calls and equivalent sort order specification structures used to organize data included in reports and displays. Subtotaling criteria often are specified in the same place as sorting criteria, as these reporting and display features are closely related. Automatic extraction of performance measures of interest can focus on filtering, sorting, and subtotaling in reports and displays.

In some implementations, automatically extracted performance measures are heuristically evaluated against multi-tenant experience with performance measures. Sales is not a new profession, though each sales organization can be somewhat unique. Based on programmed experience or machine learning of performance measures used by multiple tenant organizations that subscribe to a multi-tenant system, extracted performance measures can be evaluated and rules applied to select among candidate performance measures extracted by evaluation of the reports and displays that an organization uses. In one implementation, each tenant organization can add or define custom fields for inclusion in a standard object. Custom fields for multiple tenants are stored in a single field within the object data structure, and this single field can include different data types for each tenant. Indexing columns are also provided, wherein a tenant organization can designate a field for indexing. Data values for designated fields can be copied to an index column, and each index column can include multiple data types. Each tenant organization may also define custom objects including custom fields and indexing columns. Custom objects for multiple tenant organizations can be stored in a single custom object data structure.

Reports and displays can further be evaluated based on how frequently the reports and displays are accessed. A performance reporting system typically includes dozens of reports and displays that are used infrequently and a few reports that are used often. In the reports that are often used, filter, sorting, and subtotaling criteria typically are used repeatedly with minor variation, such as changing the filter dates to select the most recent month, quarter or rolling period. Automatically extracted performance measures can be weighted and prioritized by how often they are actually used by an organization or part of an organization. Report and display logs can be accessed to determine usage.

Human judgment can supplement automatic extraction and weighted usage, especially when many reports and displays are used. In some implementations, the technology disclosed presents a menu or pick list of performance measures from which a human user can select performance measures used to award recognition awards. The menu or pick list can be organized thematically, alphabetically, or in another order. All or part of a menu or pick list can be organized to emphasize most frequently used performance criteria and/or to rank order measures reviewed by an organization or part of an organization in reports and displays.

Extraction of performance measures, in some implementations, can be accompanied by automatic identification of progress and exception features. Progress features can be detected by stateful progression, such as completion of training unit two following training unit one. Stateful progression is often reflected in enumerated states or attribute lists. Progress also can be reflected in unstructured lists that are counted or listed. The technology disclosed can distinguish such progress features from exception features by programmed or machine learning. Exception features apply to performance measures that are quantified, as opposed to progressive, such as total sales in a month or average size of deals in a quarter. Quantitative performance measures can be statically evaluated by parametric or non-parametric methods to find exceptional good performance. In addition, quantitative performance measures can be evaluated to identify infrequent events such as first sale over $1,000,000 or first sale to the automotive industry or first sale in Ohio. Quantitative performance ranges can be evaluated to identify milestones, such as closing a deal or making an up sale. Exceptional performance criteria can be established statistically, identifying to quartile, top 10 percent or top performers for a period. Exceptional performance criteria also can be applied on a lifetime basis or to an extended evaluation period such as a year.

Scorecards can provide a high-level summary of key performance indicators (KPIs) for a given analysis area by displaying data of actual performance compared to planned targets and goals. Examples of scorecards include closed-won opportunities by month scorecard, lead activities scorecard, pipeline opportunities by close date and opportunity stage scorecard, open opportunities by created date scorecard, stage movement scorecard, opportunity conversion ratio scorecard, average closed deals size scorecard, etc.

Formula store 128 includes various filtering, sorting, and subtotaling features of the reports that can be used by performance gauge 105 to generate historical performance data 102 and current performance data 108. For instance, performance gauge 105 can calculate a “qualification rate” for a sales representative using the following formula:

Qualification Rate=[Leads/Opportunities]*100

This rate indicates what percentage of opportunities assigned to the sales representative advanced into leads. In other implementations, qualification rates can be stratified by industry types, market segments, customer segments, employee sizes, product lines, service types, stock rates, locations, and territories

In another example, a sales representative's “closing rate” can be calculated by the performance gauge 105 using the following formula:

Closing Rate=[Accounts/Prospects]*100

The closing rate can represent what percentage of leads assigned to or advanced by the sales representative got converted into accounts. In other implementations, closing rates can be stratified by industry types, market segments, customer segments, employee sizes, product lines, service types, stock rates, locations, and territories.

In yet another example, performance gauge 105 can determine the average dollar amount brought in by each sales contract secured by a particular sales representative, which is referred to as “revenue conversion rate.” This rate can be normalized by eliminating very high and low values that skew the average. Revenue conversion rates can also be stratified by industry types, market segments, customer segments, employee sizes, product lines, service types, stock rates, locations, and territories. In one implementation, performance engine 105 can use the following formula to calculate the revenue conversion rate of a sales representative:

Revenue Conversion Rate=[Revenue/Accounts]

In other implementations, performance gauge 105 can use the formulas stored in formula store 128 to calculate various performance metrics for the sales representatives, including lead response time, rate of contact, rate of follow up contact, clicks from sales follow-up emails, social media usage, usage rate of marketing collateral, opportunity-to-win ratio, average sales per sales representative, or top 20% of sales representatives.

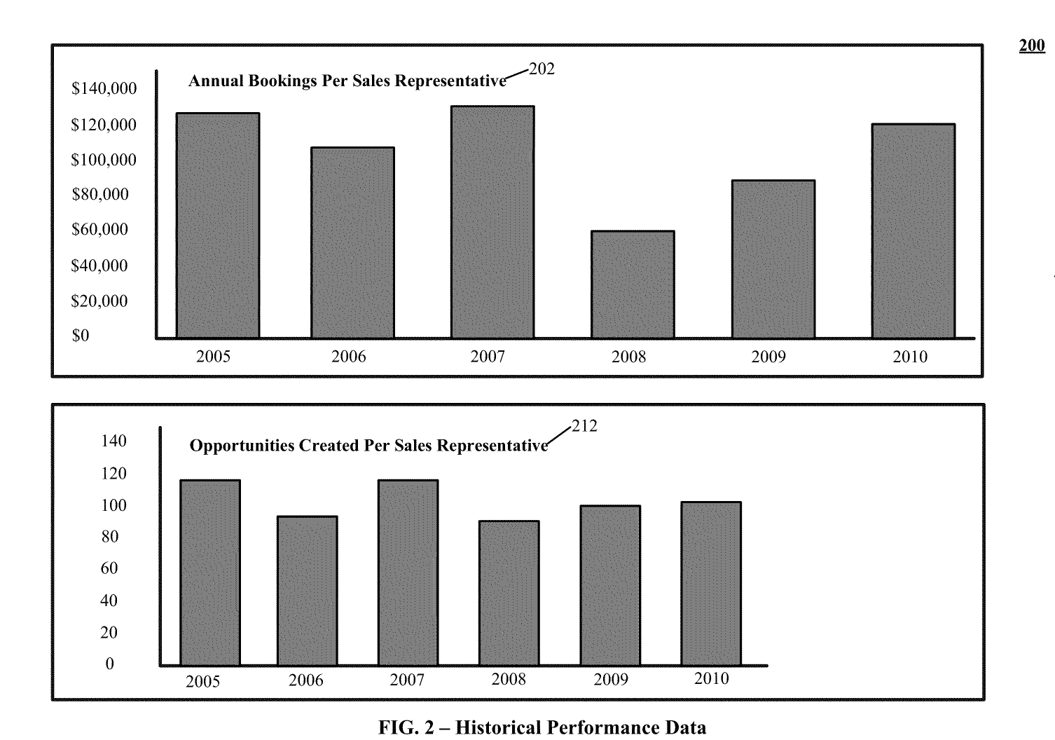

Historical performance data 102 includes data collected over time from pervious sales cycles. For instance, FIG. 2 illustrates one implementation of historical performance data 102 generated from reports. In particular, FIG. 2 shows average annual bookings 202 made by the sales representatives from the years 2005 to 2010. FIG. 2 also shows an average number of opportunities 212 created by sales representatives from the years 2005 to 2010. In other implementations, historical performance data 102 can include pipeline trend ratio, average share ratio, sales trend ratio, etc.

Current performance data 108 provides detailed performance summaries for sales representatives on quarter-by-quarter basis, including performance metrics such as conversion compared to opportunities size, opportunity conversion rate, and quota achievement. In one implementation, performance gauge 105 can analyze performance of sales representatives against goals set at the beginning of a quarter, sales activities by region and quarter, rate of sales activities by region and quarter, revenue distribution by sales region, revenue and closure trend by sales industry, quota performance by sales district, etc.

In one example, performance gauge 105 can define a “sales representative-target” table, which includes names of the sales representatives along with their yearly, quarterly, monthly, or weekly goals. It can then apply a SQL query that joins the “sales representative-target” table with a “leads-progress” table, which identifies the amount closed till date. The performance gauge 105 can further create a pivot view over the SQL query to display the sales representatives' current performance against the goals.

In another example, performance gauge 105 can apply a SQL query that joins the “sales representative-target” table with a “bookings-trends” table that identifies the average annual bookings made by the sales representatives during a period of time in the past or with a “opportunities-trends” table, which identifies the average number of opportunities created by sales representatives during a period of time in the past. The performance gauge 105 can then create a pivot view over the SQL query to display the sales representatives' current performance against the historical trends.

By constantly measuring sales representatives' current performance data 108 versus historical performance data 102 and current performance data 108 of relevant colleagues, performance gauge 105 can identify high performing sales representatives. Once the high performing sales representatives are identified, recognition trigger 125 can automatically issue recognition awards to them, which are recorded as recognition data 122.

### Progress Features

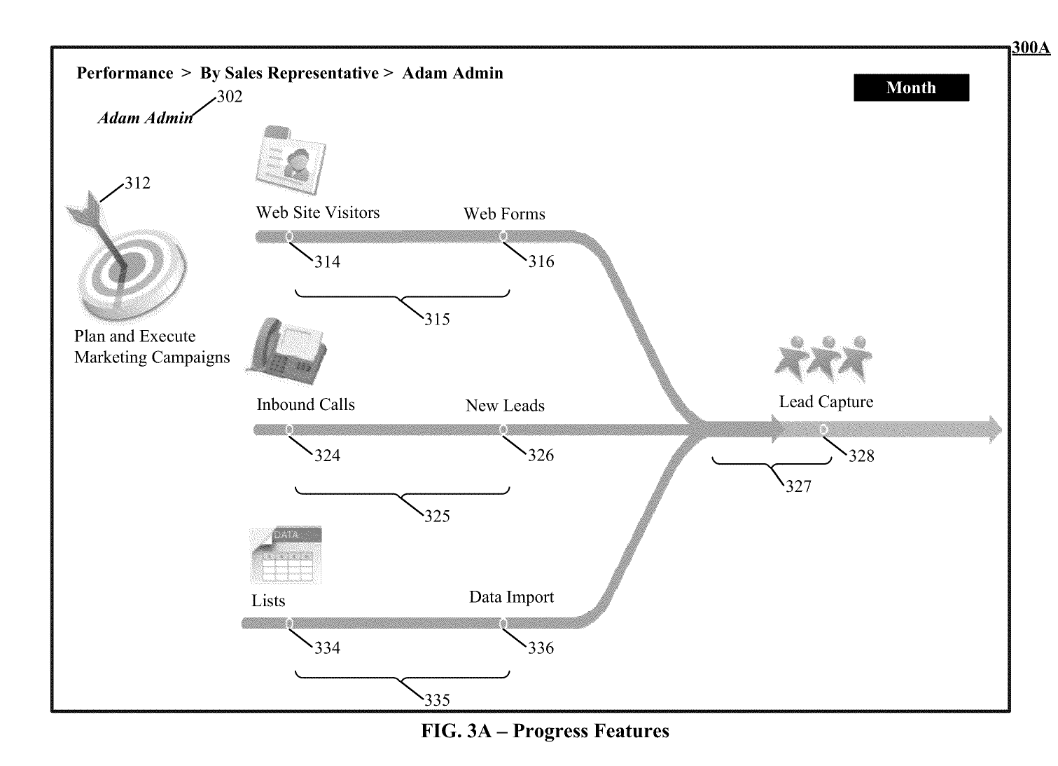

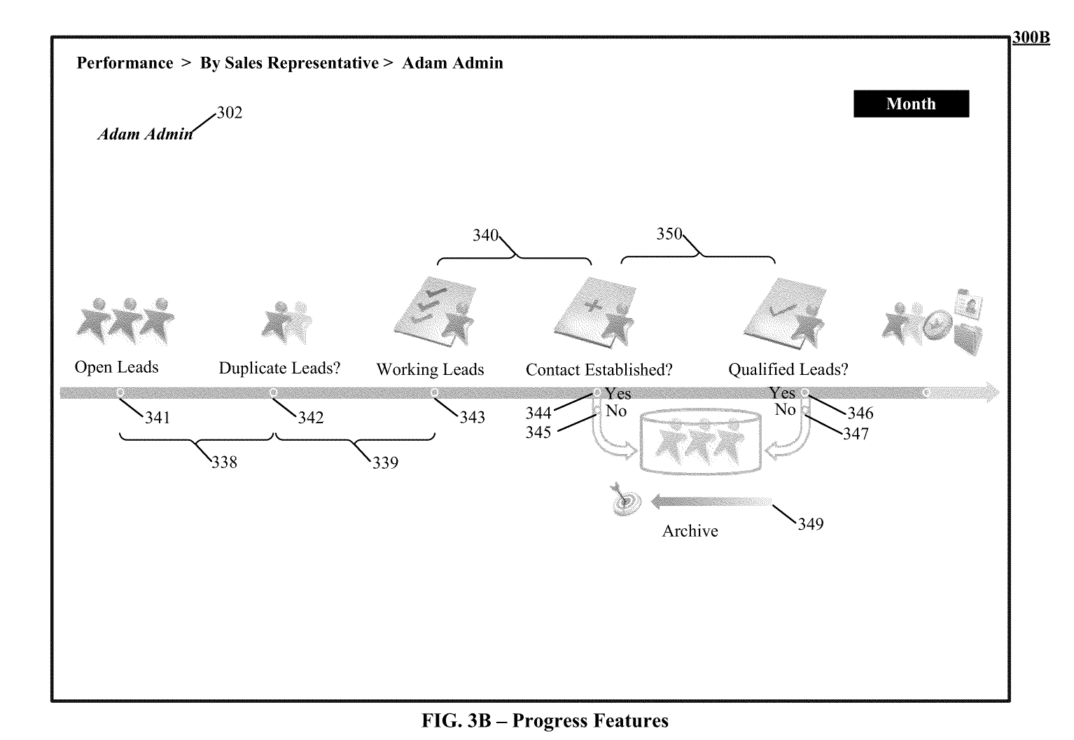

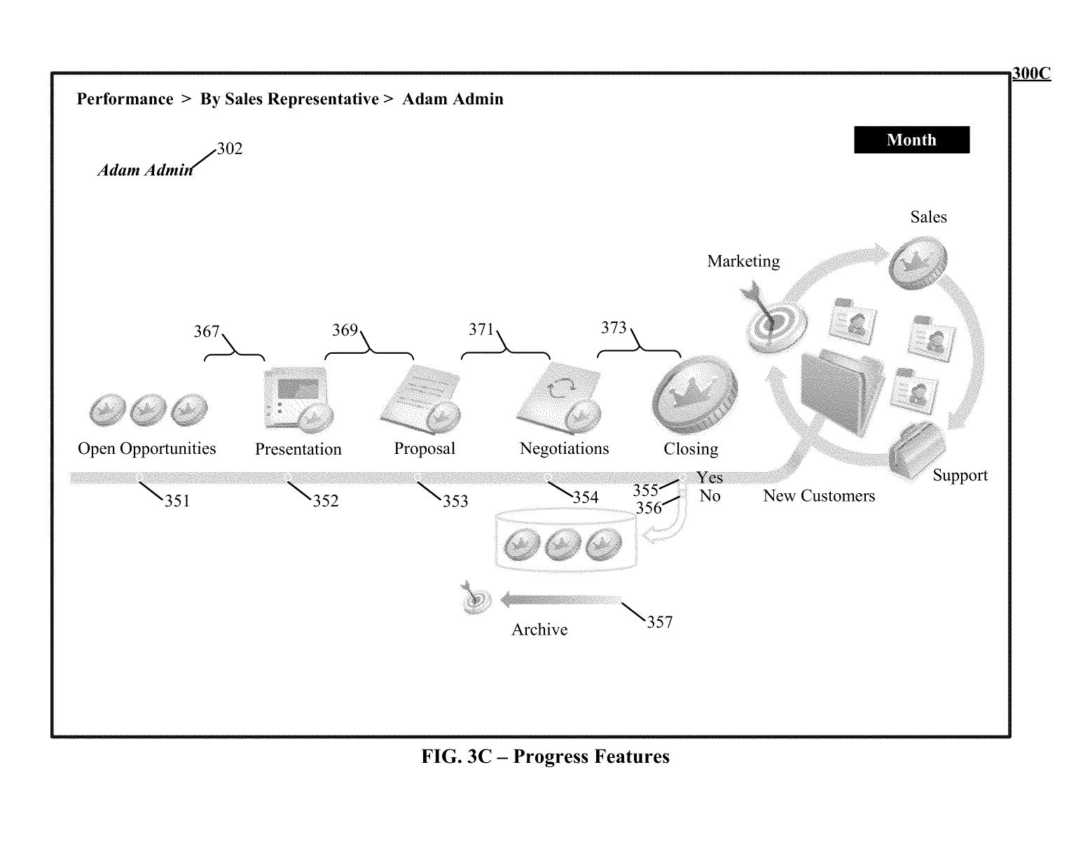

FIGS. 3A-3C illustrate one implementation of progress features extraction 300 from historical performance data 102. The progress features indicate a progression of a sales representative across a sales process map or sales cycle that represents sales flow from leads, opportunities, to accounts. FIGS. 3A-3C show various progress features, including marketing 312, lead qualification 346, presentation 352, proposal 353, negotiation 354, and closing 355. Further, FIGS. 3A-3C identify timeframes (315, 325, 335, 338, 339, 367, 369, 371, 373, etc.) within which progresses should be made from one sales performance initiative to another. For instance, when new opportunities 456 are created, a presentation 458 should be made within a timeframe 457 of 3 weeks. In other implementations, extraction 300 may not have the same features as those listed above and/or may have other/different features instead of, or in addition to, those listed above such as issue identification, ticket creation, or issue resolution. The different features can be combined into single software modules and multiple software modules can run on the same hardware.

FIGS. 3A-3C are one example of a sequence of sales performance initiatives followed by sales representatives. Performance gauge 105 extracts progress features from historical performance data 102 by automatically identifying patterns of sequence of sales performance initiatives (shown in FIGS. 3A-3C) and changes made to a sales process map in response to the sales performance initiatives. As shown in FIGS. 3A-3C, sales representatives start with planning and executing marketing campaigns 312, which includes email marketing, online ads, events, trade shows, cold calls, etc. This is followed up with capturing leads 328 by contacting web site visitors 314 using web forms 316, making inbound calls 324 to identify new leads 326, using legacy data 334, and importing contact repositories 336.

Once new leads 341 are recorded in the CRM system, the sales representatives filter out duplicate leads 342 and try to establish contact with the working leads 343. If the contact is established 344, then the working leads 343 are subjected to a qualification such as categorization based on current market situation, product of interest, etc. If the contact is not established 345, then the working leads 343 are archived. The working leads 343 that meet the qualification 346 are opened as opportunities 351 in the CRM system. Whereas, the working leads 343 that do not meet the qualification 347 are archived. Following this, sales representatives make a presentation 352, submit a proposal 353, and enter into negotiations 354. The opportunity is then either converted into an account at closing 355 or archived 357 for remarketing.

Overtime, performance gauge 105 identifies patterns of sequence of sales performance initiatives like making a presentation, which is followed by submitting a proposal, entering into negotiations, and closing. As these sales performance initiatives are entered in the CRM system, a sales funnel is simultaneously updated to reflect the progress across the sales process map or sales cycle. Performance gauge 105 then extracts the progress features by mapping the patterns of sequence of sales performance initiatives to corresponding changes in the sales funnel. Once extracted, the progress features are used as model sets for measuring a particular sales representative progress across the sales process map or sales cycle.

In other implementations, performance gauge 105 extracts progress features from historical training data by automatically identifying patterns of sequence of learning initiatives and changes made to a learning map or learning cycle in response to the learning initiatives such as orientation, training, workshops, etc. In this implementation, performance gauge 105 identifies patterns of sequence of learning initiatives like attending an orientation, which is followed by undergoing training, earning certifications, and mentoring. As these learning initiatives are entered in an education management system, a learning funnel is simultaneously updated to reflect the progress across the learning map or learning cycle. Performance gauge 105 then extracts the progress features by mapping the patterns of sequence of learning initiatives to corresponding changes in the learning funnel. Once extracted, the progress features are used as model sets for measuring a particular employee's progress across the learning map or learning cycle.

### Exception Features

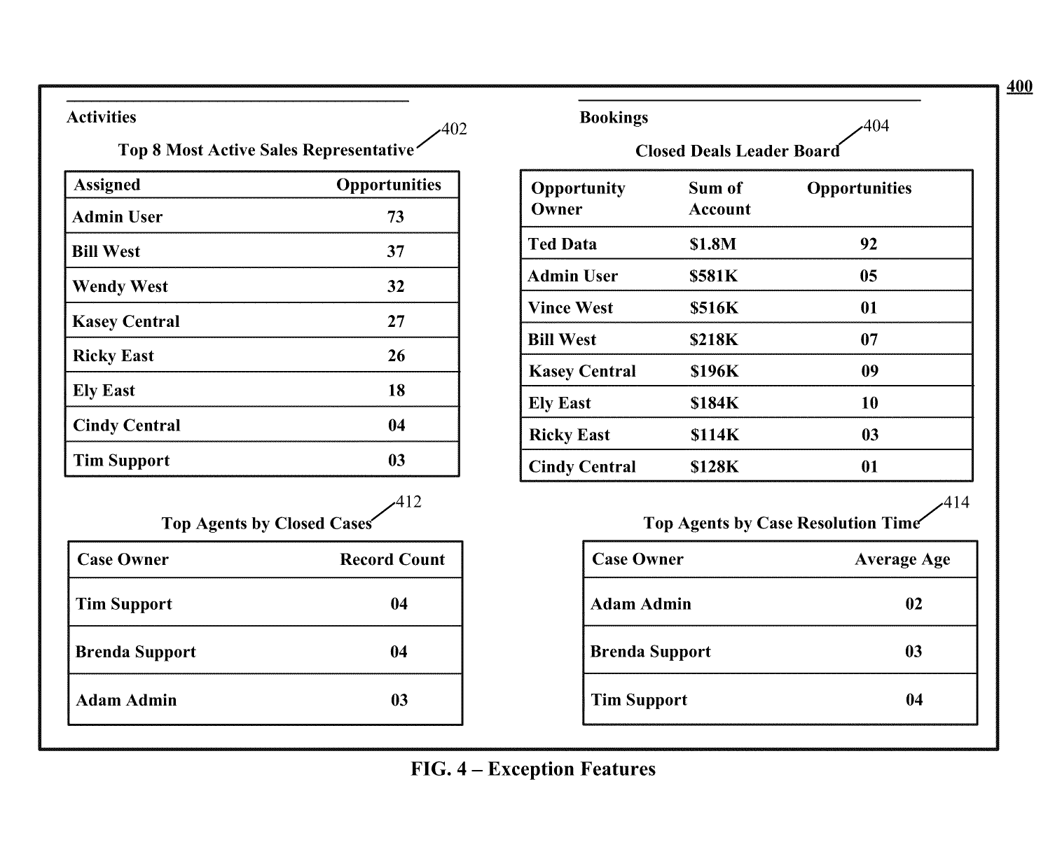

FIG. 4 shows one implementation of exception features extraction 400 from historical performance data 102. The exception features indicate high performance of a sales representative in a sales cycle. FIG. 4 illustrates various exception features, including most active sales representative 402, most revenue generating sales representative 404, top agents by closed cases 412, and top agents by case resolution time 414. In other implementations, extraction 400 may not have the same features as those listed above and/or may have other/different features instead of, or in addition to, those listed above such as highest lead response time, highest rate of contact, highest rate of follow up contact, most clicks from sales follow-up emails, most social media usage, most usage rate of marketing collateral, or most opportunity-to-win ratio. The different features can be combined into single software modules and multiple software modules can run on the same hardware.

Performance gauge 105 extracts exception features from historical performance data 102 by applying top ranking functions that limit the number of value returned in the final output. In some implementations, top-ranking functions can be used to produce performance metrics that include in the final output only the top n values within certain subgroups. In one implementation, performance gauge 105 can use the following formulas to return a numerical rank for a performance metric in ascending or descending order:

SELECT RANK(Avg. Won)
SELECT RANK(Amount) ASC WITHIN(YEAR(Closed))
SELECT RANK(Amount[SUM]) WITHIN(CURRENT)
SELECT RANK(Amount[SUM]) WITHIN(ALL OTHER)

In other implementations, performance gauge 105 can identify high performing sales representatives by applying the following top-ranking functions:

SELECT ... WHERE TOP (...) OF ... [WITHIN ...]
SELECT metric1 WHERE [TOP] (n or n%) OF ( metric2, ...)
SELECT metric1 WHERE [TOP] (n or n%) OF ( metric2, ...)
WITHIN (...)

In one example, the above formulas can be used to return the top 8 most active sales representatives in a sales division. In another example, the above formulas can be used to generate pivot views that display top 20% of sales representative relative to the number of closed deals and amount of revenue collected.

### Auto Recognition

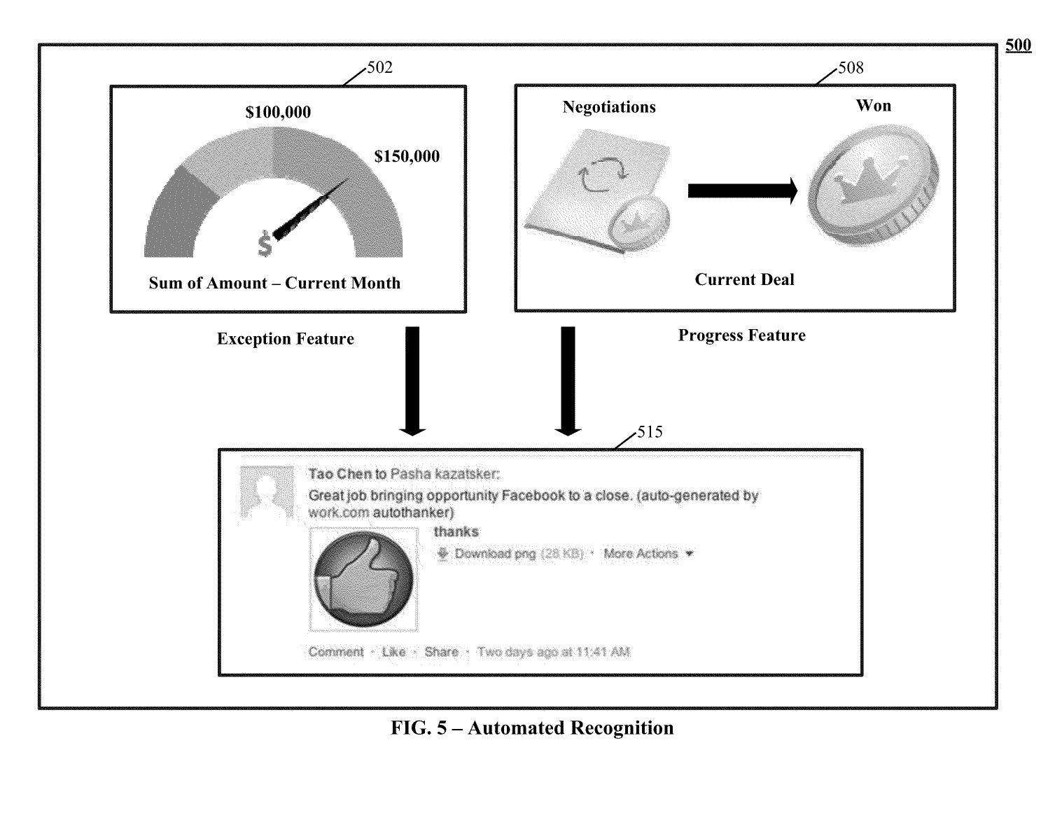

FIG. 5 illustrates one implementation of automated recognition 500 of users in an on-demand system. Recognition trigger 125 can automatically issue recognition award 515 by evaluating the current performance of sales representatives against the progress features (FIGS. 3A-3C) and the exception features (FIG. 4). In one implementation, recognition awards are automatically awarded based on the progress feature 508 as the current performance data 108 evidences accomplishment of milestones. In another implementation, recognition awards are automatically awarded based on the exception feature 502 as the current performance data 108 evidences high performance.

As shown in FIG. 5, a recognition award 515 (badge and thanks) is automatically issued to a sales representative ‘Pasha Kazatsker’ on behalf of his manager ‘Tao Chen’, when the sales representative's monthly revenue crosses a base line revenue of $100,000 and reaches $150,000 (exception feature 502). In other implementations, a recognition award 515 is automatically issued to the sales representative on behalf of his manager, when the sales representative progresses a deal from negotiation to closing (progress feature 508).

In other implementations, recognition trigger 125 can automatically issue recognition awards using Apex triggers. Triggers can act as scripts that execute before or after specific data manipulation language (DML) events occur, such as before object records are inserted into the database, timestamps values are recorded, or after records have been deleted. For instance, when a sales representative closes an opportunity, recognition trigger 125 can use the following Apex code to issue a recognition award like a badge or thanks:

```
Trigger giveThanks on Opportunity (after update) {
  for (Opportunity opp : Trigger.new){
  if ( (opp.stagename == ‘Closed Won’ ) &&
(trigger.oldMap.get(opp.id).stagename != ‘Closed Won’) ) {
    WorkConnector.SendThanksAndPostToChatter(trigger.new[0].id,
false); }}}
```

In the Apex code above, when the opportunity's stage name is updated in a CRM system to be closed or won (Opportunity Stagename=‘Closed Won’), the Apex trigger (giveThanks) can call an Apex class called ‘WorkConnector’ according to one implementation, which can post the issued badge or thanks in one or more social profiles of the recipient, including Chatter, Facebook, Twitter, etc. In other implementations, depending on the size of the closed opportunity (opportunity.amount), the Apex trigger can issue varying recognition awards, as shown in the Apex code below:

```
if (opportunity.amount = 10000) {
  badgeHashWord = ‘rock’;
} else if (opportunity.amount >= 10000) {
  badgeHashWord = ‘thanks’;
} else {
  return;}
```

### Award Building

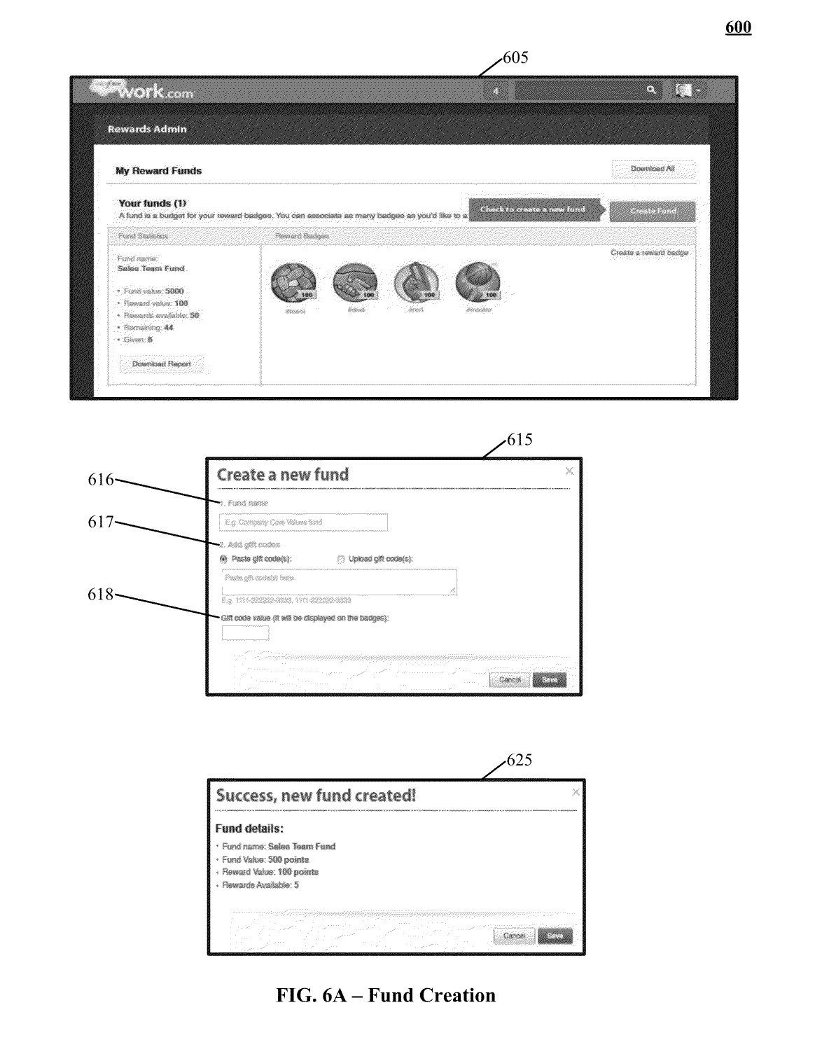

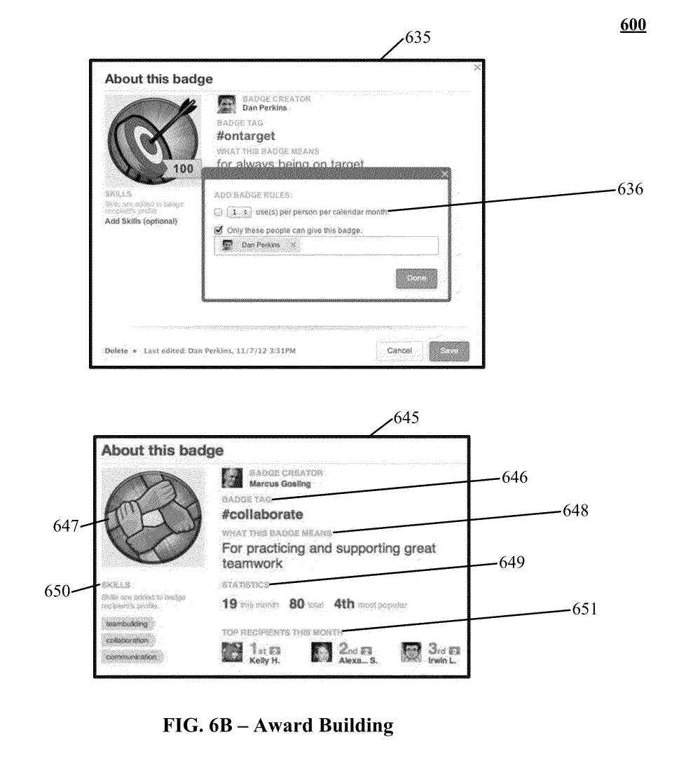

FIGS. 6A and 6B are one implementation of user triggered recognition 600 of users in an on-demand system. FIG. 6A shows fund creation interfaces (605, 615, and 625) and FIG. 6B shows award building interfaces (635 and 645). In other implementations, recognition 600 may not have the same screen objects, interfaces, or widgets as those listed above and/or may have other/different screen objects, interfaces, or widgets instead of, or in addition to, those listed above such as ratings, metrics, scorings, performance calibrations, etc. The different elements can be combined into single software modules and multiple software modules can run on the same hardware.

Interfaces 605-645 can take one of a number of forms, including user interfaces, dashboard interfaces, engagement consoles, and other interfaces, such as mobile interfaces, tablet interfaces, summary interfaces, or wearable interfaces. In some implementations, they can be hosted on a web-based or cloud-based application running on a computing device. They can also be hosted on a non-social local application running in an on-premise environment. In one implementation, they can be accessed from a browser running on a computing device. The browser can be Chrome, Internet Explorer, Firefox, Safari, and the like. In other implementations, interfaces 605-645 can run as engagement consoles on a computer desktop application.

A manager can create a new reward fund using interfaces 605 and 615. In one implementation, interfaces 605 and 615 can: accept a fund name 616, add gift codes 617, and assign values to the gift codes 618. Interface 625 shows a completed reward fund and identifies the fund name as ‘Sales Team Fund’, fund value as ‘500 points’, reward value as ‘100 points’, and available reward as ‘5’.

As shown in FIG. 6B, interfaces 625 and 635 accept specifications from managers for customizing the recognition award. In some implementations, specifications include one or more images 647 for the recognition award, tags 646 for the recognition award, description 648 of the recognition award, rules 636 for awarding the recognition award, and skills profiling 650 of intended recipients of the recognition award, statistics 649 associated with the recognition award, and top recipients 651 of the recognition award. In some implementations, the rules 636 for awarding the recognition award can specify per person limits on the assignment of the recognition award and also assign privileges to one or more users for awarding the recognition award. In some other implementations, skills 650 profiling of intended recipients of the recognition award can list various skills such as adaptability, creativity, customer advocacy, decisiveness, determination, initiative, or mastery.

### Recognition Schema

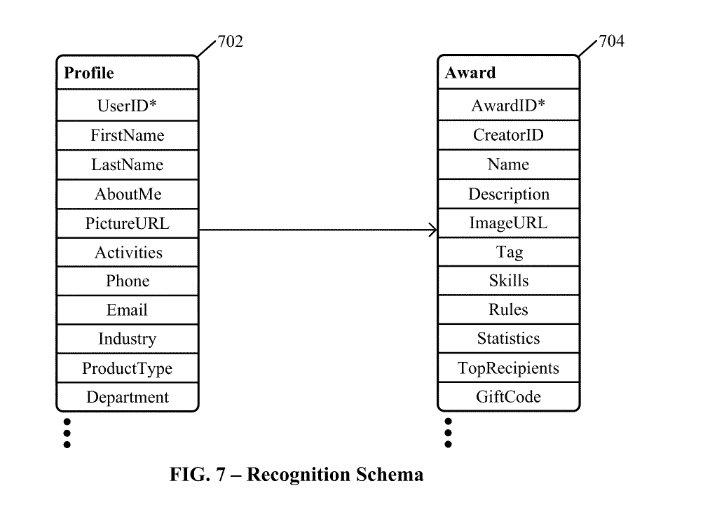

FIG. 7 is one implementation of a recognition schema 700 that can be used for rewarding users in an on-demand system. This and other data structure descriptions that are expressed in terms of objects can also be implemented as tables that store multiple records or object types. Reference to objects is for convenience of explanation and not as a limitation on the data structure implementation. FIG. 7 shows a profile object 702 linked to an award object 704. In other implementations, recognition schema 700 may not have the same objects, tables, fields or entries as those listed above and/or may have other/different objects, tables, fields or entries instead of, or in addition to, those listed above such as a statistics object, rules object, or skills object.

As shown in FIG. 7, recognition schema 700 is updated to record assignments of recognition awards to a sales representative. In one implementation, profile object 702 provides primary information that identifies a sales representative and includes various fields that store biographic information about the sales representative such as first name, last name, sex, birthday, department, interests, etc. In some implementations, the profile object 702 can be further linked to other objects that provide supplementary information about the sales representative.

In some implementations, profile object 702 is linked to an award object 704, which identifies the recognition awards awarded to the sales representative. Award object 704 includes a field referred to as ‘AwardID*’ that uniquely identifies a recognition award. It also includes other fields such as: ‘CreatorID’ that identifies the owner of the recognition award, ‘Name’ that identifies the name assigned to the recognition award, ‘Description’ that provides a summary of the recognition award, ‘ImageURL’ that holds the image given to the recognition award, ‘Tag’ that specifies the tag given to the recognition award, ‘Skills’ that identifies the skills attributed to the recipient of the recognition award, ‘Rules’ that specifies the rules for awarding the recognition award, ‘Statistics’ that identifies the statistics associated with the recognition awards, ‘TopRecipients’ that specifies the users who have being awarded the recognition award most number of times within a time period, and ‘GiftCode’ that identifies one or more gift rewards linked to the recognition award.

In yet another implementation, schema 700 can have one or more of the following variables with certain attributes: USER_ID being CHAR (15 BYTE), TOP_RECIPIENTS_ID being CHAR (15 BYTE), GIFT_CODE_ID being CHAR (15 BYTE), SUMMARY_ID being CHAR (15 BYTE), TAG_FORMAT_ID being CHAR (15 BYTE), RULES_ID being CHAR (15 BYTE), CREATED_BY being CHAR (15 BYTE), CREATED_DATE being DATE, and DELETED being CHAR (1 BYTE).

### Flowchart of Rewarding Users in an On-Demand System

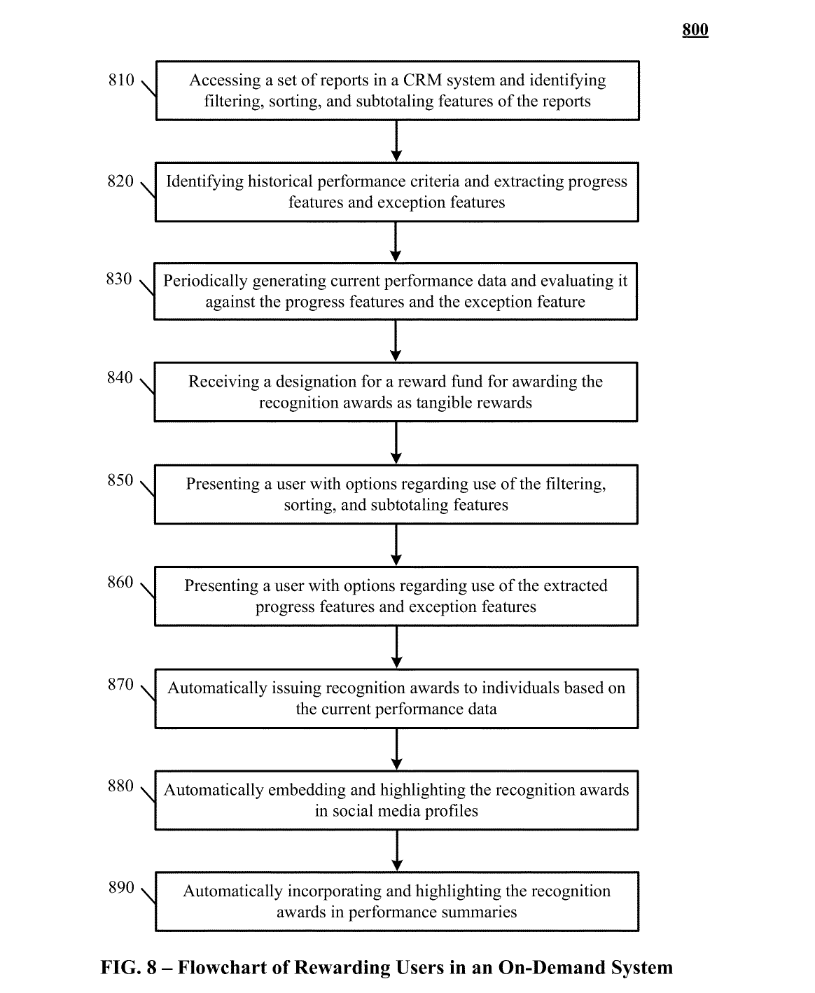

FIG. 8 is a flowchart 800 of one implementation of rewarding users in an on-demand system. Flowchart 800 can be implemented at least partially with a database system, e.g., by one or more processors configured to receive or retrieve information, process the information, store results, and transmit the results. Other implementations may perform the actions in different orders and/or with different, fewer or additional actions than the ones illustrated in FIG. 8. Multiple actions can be combined in some implementations. For convenience, this flowchart is described with reference to the system that carries out a method. The system is not necessarily part of the method.

At action 810, a set of reports in a CRM system is accessed and filtering, sorting, and subtotaling features of the reports are identified. A CRM system allows organizations to manage business relationships and the data and information associated with them. It allows organizations to store customer and contact information as reports. A report returns a set of records that meets certain criteria, and displays it in organized rows and columns. Report data can be filtered, grouped, sorted, and displayed graphically as a chart. A report type defines the set of records and fields available to a report based on the relationships between a primary object and its related objects.

At action 820, historical performance criteria are identified using the filtering, sorting, and subtotaling features of the reports and historical performance data is analyzed to extract progress features and exception features of the historical performance data. The progress features indicate a progression of an individual, and the exception features indicate high performance of an individual. Analyzing the historical performance data to extract progress features includes automatically identifying at least patterns of sequence of sales performance initiatives and changes to a sales process map in response to the sales performance initiatives. Also, analyzing the historical performance data to extract exception features includes automatically identifying high performances by applying top ranking functions.

At action 830, current performance data is periodically generated and evaluated against the progress features and the exception feature. In particular, sales representatives' current performance can be analyzed against: goals set at the beginning of a quarter, sales activities by region and quarter, revenue distribution by sales region, revenue and closure trend by sales industry, quota performance by sales district, etc. to identify high performing sales representatives.

At action 840, a designation for a reward fund for awarding the recognition awards as tangible rewards is received and linked to one or more recognition awards. In some implementations, the reward fund can be used to create tangible rewards redeemable from e-commerce platforms external to the CRM system such as Amazon.com, eBay, etc. In one implementation, such tangible rewards can include electronic gift codes of specific values. For instance, a manger can create a $20,000 fund to implement a company-wide reward program where individuals can recognize each other for exemplifying company values and then associate reward badges for each of the company values.

At action 850, a user is presented with options regarding use of the filtering, sorting, and subtotaling features to extract progress features and exception features. In some implementations, the identified filtering, sorting, and subtotaling features can be displayed to the user for approval. In other implementations, the user can customize the fields, range, or variables of the filtering, sorting, and subtotaling features.

At action 860, a user is presented with options regarding use of the extracted progress features and exception features to automatically issue at least one of recognition awards. In some implementations, the extracted progress features and exception features can be displayed to the user for approval of which extracted progress features and exception features should be awarded or how many extracted progress features and exception features should be awarded. In other implementations, the user can customize the recognition awards by specifying at least one of: one or more images for the recognition awards, tags for the recognition awards, description of the recognition awards, rules for awarding the recognition awards, and skills profiling of intended recipients of the recognition awards.

At action 870, recognition awards are automatically issued to individuals based on the current performance data. The recognition awards are automatically awarded based on the progress features as the current performance data evidences accomplishment of milestones. The recognition awards are also automatically awarded based on the exception features as the current performance data evidences high performance.

At action 880, the recognition awards are automatically embedded and highlighted in social media profiles (Chatter, Facebook, Twitter, etc.) of recipients of the recognition awards. In some implementations, the recognition awards can be posted as binary content type in the feeds of the social media profiles.

At action 890, the recognition awards are automatically incorporated and highlighted in performance summaries of recipients of the recognition awards. In some implementations, the recognition awards can be posted as binary content type in the CRM system providing the performance summaries.

### Computer System

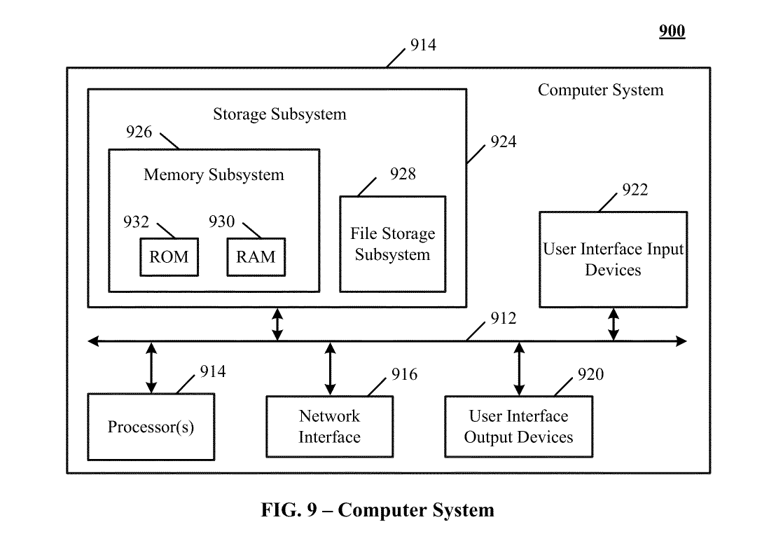

FIG. 9 is a block diagram of an example computer system 900 used for rewarding users in an on-demand system. FIG. 9 is a block diagram of an example computer system, according to one implementation. Computer system 910 typically includes at least one processor 914 that communicates with a number of peripheral devices via bus subsystem 912. These peripheral devices can include a storage subsystem 924 including, for example, memory devices and a file storage subsystem, user interface input devices 922, user interface output devices 920, and a network interface subsystem 916. The input and output devices allow user interaction with computer system 910. Network interface subsystem 916 provides an interface to outside networks, including an interface to corresponding interface devices in other computer systems.

User interface input devices 922 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 910.

User interface output devices 920 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 910 to the user or to another machine or computer system.

Storage subsystem 924 stores programming and data constructs that provide the functionality of some or all of the modules and methods described herein. These software modules are generally executed by processor 914 alone or in combination with other processors.

Memory 926 used in the storage subsystem can include a number of memories including a main random access memory (RAM) 930 for storage of instructions and data during program execution and a read only memory (ROM) 932 in which fixed instructions are stored. A file storage subsystem 928 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 928 in the storage subsystem 924, or in other machines accessible by the processor.

Bus subsystem 912 provides a mechanism for letting the various components and subsystems of computer system 910 communicate with each other as intended. Although bus subsystem 912 is shown schematically as a single bus, alternative implementations of the bus subsystem can use multiple busses.

Computer system 910 can be of varying types including a workstation, server, computing cluster, blade server, server farm, or any other data processing system or computing device. Due to the ever-changing nature of computers and networks, the description of computer system 910 depicted in FIG. 9 is intended only as one example. Many other configurations of computer system 910 are possible having more or fewer components than the computer system depicted in FIG. 9.

### Particular Implementations

In one implementation, a method is described from the perspective of a server receiving messages from user software. The method includes accessing a set of reports in a CRM system and identifying filtering, sorting, and subtotaling features of the reports. It also includes identifying historical performance criteria using the filtering, sorting, and subtotaling features of the reports and analyzing historical performance data for the identified criteria to extract progress features and exception features. The progress features indicate a progression of an individual, and the exception features indicate high performance of an individual. It further includes periodically generating current performance data and evaluating the current performance data against the progress features and the exception features and automatically issuing recognition awards to individuals based on the current performance data. The recognition awards are automatically awarded based on the progress features as the current performance data evidences accomplishment of milestones. The recognition awards are also automatically awarded based on the exception features as the current performance data evidences high performance.

This and other method described can be presented from the perspective of a mobile device and user software interacting with a server. From the mobile device perspective, the method accesses a set of reports in a CRM system and relies on a server to identify filtering, sorting, and subtotaling features of the reports. It also includes the server generating historical performance data using the filtering, sorting, and subtotaling features of the reports and analyzing the historical performance data to extract progress features and exception features of the historical performance data. The progress features indicate a progression of an individual, and the exception features indicate high performance of an individual. It further includes the server periodically generating current performance data and evaluating the current performance data against the progress features and the exception feature and automatically issuing recognition awards to individuals based on the current performance data. The recognition awards are automatically awarded based on the progress features as the current performance data evidences accomplishment of milestones. The recognition awards are also automatically awarded based on the exception features as the current performance data evidences high performance.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations such as recognition environment, progress features, exception features, auto recognition, award building, or recognition schema.

Analyzing the historical performance data to extract progress features includes automatically identifying at least one of patterns of sequence of sales performance initiatives and changes to a sales process map in response to the sales performance initiatives. Analyzing the historical performance data to extract exception features includes automatically identifying high performances by applying top ranking functions.

The method also includes presenting a user with options regarding use of the filtering, sorting, and subtotaling features to extract progress features and exception features. It further includes presenting a user with options regarding use of the extracted progress features and exception features to automatically issue at least one of recognition awards.

The method also includes automatically awarding the recognition awards as tangible rewards redeemable from e-commerce platforms external to the CRM system. It further includes receiving a designation for a reward fund for awarding the recognition awards as tangible rewards and linking one or more recognition awards to the reward fund.

The method also includes customizing the recognition awards by receiving at least one of one or more images for the recognition awards, tags for the recognition awards, description of the recognition awards, rules for awarding the recognition awards, and skills profiling of intended recipients of the recognition awards. It includes automatically embedding and highlighting the recognition awards in social media profiles of recipients of the recognition awards. It further includes automatically incorporating and highlighting the recognition awards in performance summaries of recipients of the recognition awards.

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

While the present technology is disclosed by reference to the preferred implementations and examples detailed above, it is to be understood that these examples are intended in an illustrative rather than in a limiting sense. It is contemplated that modifications and combinations will readily occur to those skilled in the art, which modifications and combinations will be within the spirit of the technology and the scope of the following claims.

1. A method, including:
accessing a set of reports in a CRM system to identify historical performance data'
analyzing the historical performance data for one or more historical performance criteria to extract progress features and exception features;
periodically generating current performance data; and
evaluating the current performance data against the progress features and the exception features and automatically issuing recognition awards to individuals based on the current performance data, wherein
recognition awards are automatically awarded based on the progress features as the current performance data evidences accomplishment of milestones; and
recognition awards are automatically awarded based on the exception features as the current performance data evidences high performance.

2. The method of claim 1, wherein analyzing the historical performance data to extract progress features includes automatically identifying at least one of:
patterns of sequence of sales performance initiatives; and
changes to a sales process map in response to the sales performance initiatives.

3. The method of claim 1, wherein analyzing the historical performance data to extract exception features includes automatically identifying high performances by applying top ranking functions.

4. The method of claim 1, wherein the historical performance data are identified using filtering, sorting, and subtotaling features of the reports.

5. The method of claim 4, further including presenting a user with options regarding use of the filtering, sorting, and subtotaling features to extract progress features and exception features.

6. The method of claim 1, further including presenting a user with options regarding use of the extracted progress features and exception features to automatically issue at least one of recognition awards.

7. The method of claim 1, further including automatically awarding the recognition awards as tangible rewards redeemable from e-commerce platforms external to the CRM system.

8. The method of claim 7, further including receiving a designation for a reward fund for awarding the recognition awards as tangible rewards and linking one or more recognition awards to the reward fund.

9. The method of claim 1, further including customizing the recognition awards by receiving at least one of:
one or more images for the recognition awards;
tags for the recognition awards;
description of the recognition awards;
rules for awarding the recognition awards; and
skills profiling of intended recipients of the recognition awards.

10. The method of claim 1, further including automatically embedding and highlighting the recognition awards in social media profiles of recipients of the recognition awards.

11. The method of claim 1, further including automatically incorporating and highlighting the recognition awards in performance summaries of recipients of the recognition awards.

12. A system, including:
a processor and a computer readable storage medium storing computer instructions configured to cause the processor to:
access a set of reports in a CRM system to identify historical performance data'
analyze the historical performance data for one or more historical performance criteria to extract progress features and exception features;
periodically generate current performance data; and
evaluate the current performance data against the progress features and the exception features and automatically issue recognition awards to individuals based on the current performance data, wherein
recognition awards are automatically awarded based on the progress features as the current performance data evidences accomplishment of milestones; and
recognition awards are automatically awarded based on the exception features as the current performance data evidences high performance.

13. The system of claim 12, wherein analyzing the historical performance data to extract progress features includes automatically identifying at least one of:
patterns of sequence of sales performance initiatives; and
changes to a sales process map in response to the sales performance initiatives.

14. The system of claim 12, wherein analyzing the historical performance data to extract exception features includes automatically identifying high performances by applying top ranking functions.

15. The method of claim 12, wherein the historical performance data are identified using filtering, sorting, and subtotaling features of the reports.

16. The system of claim 15, further configured to cause the processor to present a user with options regarding use of the filtering, sorting, and subtotaling features to extract progress features and exception features.

17. The system of claim 12, further configured to cause the processor to present a user with options regarding use of the extracted progress features and exception features to automatically issue at least one of recognition awards.

18. The system of claim 12, further configured to cause the processor to automatically award the recognition awards as tangible rewards redeemable from e-commerce platforms external to the CRM system.

19. The system of claim 18, further configured to cause the processor to receive a designation for a reward fund for awarding the recognition awards as tangible rewards and linking one or more recognition awards to the reward fund.

20. The system of claim 12, further configured to cause the processor to customize the recognition awards by receiving at least one of:
one or more images for the recognition awards;
tags for the recognition awards;
description of the recognition awards;
rules for awarding the recognition awards; and
skills profiling of intended recipients of the recognition awards.
